(19) United States
(12) Patent Application Publication
(10) Pub. No.: US 2006/0200868 A1
(43) Pub. Date: Sep. 7, 2006

(54) Information processing device and information processing method

(76) Inventor: Toru Harada, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/365,529

(22) Filed: Mar. 2, 2006

(30) Foreign Application Priority Data
Mar. 7, 2005 (JP) 2005-062622
Feb. 22, 2006 (JP) 2006-045341

(51) Int. Cl. G06F 11/00

(52) U.S. Cl. 726/34

(57) ABSTRACT

In an information processing device which prevents erroneous initialization of a removable recording medium in which a program is recorded, an acquisition unit acquires the program and identification information of the recording medium from the recording medium. A first inspection unit checks authenticity of the acquired program. A second inspection unit checks authenticity of the acquired identification information. A determination unit determines correctness of initialization of the recording medium based on inspection results of the first and second inspection units.

### BACKGROUND OF THE INVENTION

1. Field of The Invention

The present invention relates to an information processing device and an information processing method which prevent erroneous initialization of a recording medium in which a program is recorded.

2. Description of The Related Art

An information processing device, such as a personal computer, is capable of performing various information processing procedures by executing one or more programs which correspond to the information processing procedures respectively.

A multi-function image forming device (called MFP) is an application device of the information processing device. In the MFP, a display part, a printing part, an imaging part etc. are installed in a single housing, and four kinds of application programs corresponding to a printer, a copier, a facsimile and a scanner are provided. In the MFP, one of the application programs is selectively executed so that the MFP is made to operate as one of the printer, the copier, the facsimile and the scanner.

When the above-mentioned information processing device or the MFP is powered up, the BIOS (basic input/output system) and the boot loader are initiated. The boot loader develops the operating system (OS) and the root file system on the RAM and starts execution of the OS. The OS performs mounting of the root file system. The “mounting” means that the file system, the peripheral devices, etc. be set in a state that they can be accessed.

After the OS is started, the boot program which starts the programs, such as the application programs, is initiated. The boot program results in a process that is first started in the information processing device or the MFP. The boot program performs mounting of the file system in accordance with a given configuration file.

The programs needed for operation of the information processing device or the MFP are recorded in a boot-program recording medium such as a hard disk drive (HDD) or a SD (Secure Digital) card, and started in accordance with the given configuration file.

In recent years, the demand for easily performing the addition of a program of the information processing device or the MFP to the boot-program recording medium is increasing.

To meet the demand for easily adding a program to a removable boot-program recording medium, there is proposed a method of adding the program to the boot-program recording medium while securing the safety of the existing programs recorded on the boot-program recording medium. See Japanese Laid-Open Patent Application No. 2004-287622.

However, the above-mentioned method is not provided with any special restriction for initialization of the boot-program recording medium when adding the program. The only countermeasure actually taken by the above method is the prevention of erroneous recording or rewriting of the recording medium using the write-inhibit switch or the like.

Accordingly, when the user is going to temporarily initialize the user data (address book, etc.) in the recording medium for use of the medium, the recording medium in which the programs are recorded may be erroneously initialized by such operation of the user. For this reason, there is a problem that the information processing device or the MFP requires the mechanism for preventing erroneous initialization of a removable recording medium from occurring by operation of the user.

### SUMMARY OF THE INVENTION

An object of the present invention is to provide an improved information processing device and method in which the above-described problems are eliminated.

Another object of the present invention is to provide an information processing device which is provided to safely prevent the removable recording medium in which the program is recorded from being erroneously initialized by operation of the user.

Another object of the present invention is to provide an information processing method which is provided to safely prevent the removable recording medium in which the program is recorded from being erroneously initialized by operation of the user.

In order to achieve the above-mentioned objects, the present invention provides an information processing device which prevents erroneous initialization of a removable recording medium in which a program is recorded, the information processing device comprising: an acquisition unit which acquires the program and identification information of the recording medium from the recording medium; a first inspection unit checking authenticity of the acquired program; a second inspection unit checking authenticity of the acquired identification information; and a determination unit determining correctness of initialization of the recording medium based on inspection results of the first and second inspection units.

The above-mentioned information processing device may be configured so that the identification information includes a plurality of marks which are linked by address information being given respectively, and a plurality of character strings contained in the plurality of marks respectively.

The above-mentioned information processing device may be configured so that the second inspection unit is provided to search a plurality of marks, contained in the identification information, by using address information given to each of the plurality of marks, and provided to determine whether a character string contained in a searched mark matches with a predetermined character string for the recording medium.

The above-mentioned information processing device may be configured so that the address information given to each of the plurality of marks links the plurality of marks in the recording medium and enables searching of each mark.

The above-mentioned information processing device may be configured so that execution of initialization of the recording medium is inhibited when at least one of the inspection results of the first and second inspection units indicates authenticity of the program or the identification information.

In order to achieve the above-mentioned objects, the present invention provides an information processing method which prevents erroneous initialization of a removable recording medium in which a program is recorded, the information processing method comprising: an acquisition step of acquiring the program and identification information of the recording medium from the recording medium; a first inspection step of checking authenticity of the acquired program; a second inspection step of checking authenticity of the acquired identification information; and a determination step of determining correctness of initialization of the recording medium based on inspection results of the first and second inspection steps.

The above-mentioned information processing method may be configured so that the identification information includes a plurality of marks which are linked by address information being given respectively, and a plurality of character strings contained in the plurality of marks respectively.

The above-mentioned information processing method may be configured so that the second inspection step is provided to search a plurality of marks, contained in the identification information, by using address information given to each of the plurality of marks, and provided to determine whether a character string contained in a searched mark matches with a predetermined character string for the recording medium.

The above-mentioned information processing method may be configured so that the address information given to each of the plurality of marks links the plurality of marks and enables searching of each mark.

The above-mentioned information processing method may be configured so that execution of initialization of the recording medium is inhibited when at least one of the inspection results of the first and second inspection steps indicates authenticity of the program or the identification information.

According to the present invention, it is possible to provide an information processing device and an information processing method which are provided to safely prevent the removable recording medium in which the program is recorded from being erroneously initialized by operation of the user.

### BRIEF DESCRIPTION OF THE DRAWINGS

Other objects, features and advantages of the present invention will be apparent from the following detailed description when reading in conjunction with the accompanying drawings.

FIG. 1 is a diagram showing the hardware composition of an information processing device in an embodiment of the invention.

FIG. 2 is a diagram showing the composition of a firmware distribution system.

FIG. 3 is a diagram showing the arrangement of objects on a recording medium.

FIG. 4 is a diagram showing the use of a recording medium in an image forming device.

FIG. 5 is a diagram showing the hardware composition of an image forming device in an embodiment of the invention.

FIG. 6 is a diagram for explaining the mechanism for preventing the recording medium from being initialized erroneously.

FIG. 7 is a flowchart for explaining an initialization correctness detection processing for a recording medium.

FIG. 8 is a diagram showing an example of the display screen for not initializing the recording medium erroneously.

FIG. 9 is a diagram for explaining an example of a mark checking method which is applied to the initialize program.

FIG. 10 is a diagram showing the composition of a memory card which is prepared by the firmware distribution system.

FIG. 11 is a diagram showing the software composition of the image forming device in an embodiment of the invention.

FIG. 12 is a diagram for explaining the initialization procedure of the recording medium which is performed by the user.

### DETAILED DESCRIPTION OF PREFERRED EMBODIMENTS

A description will now be given of an embodiment of the invention with reference to the accompanying drawings.

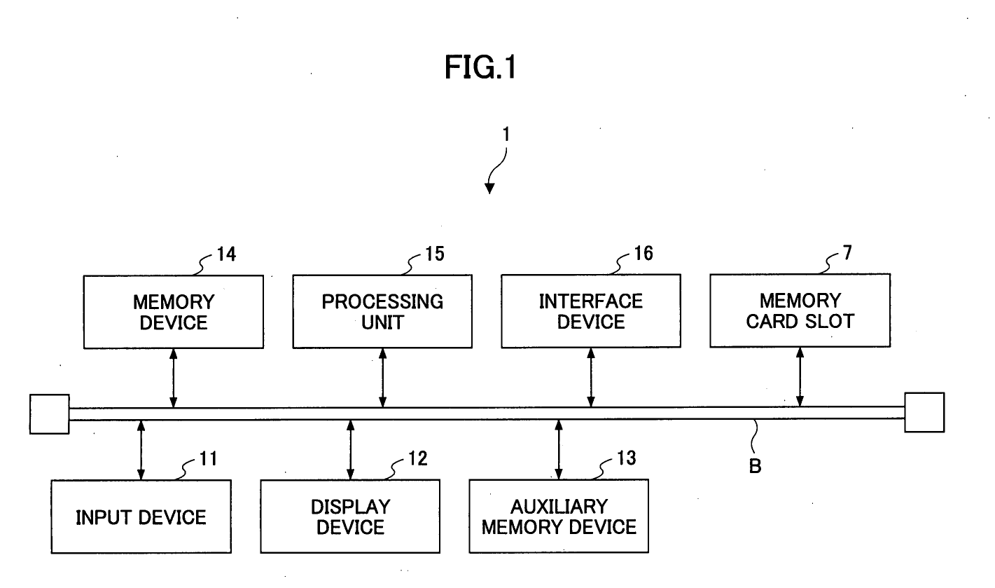

FIG. 1 shows the hardware composition of an information processing device in an embodiment of the invention.

As shown in FIG. 1, the information processing device 1 comprises an input device 11, a display device 12, an auxiliary memory device 13, a memory device 14, a processing unit 15, an interface device 16, and a memory card slot 7. The input device 11, the display device 12, the auxiliary memory device 13, the memory device 14, the processing unit 15, the interface device 16, and the memory card slot 7 are interconnected by the bus B.

The input device 11 comprises a keyboard, a mouse, etc., and it is used in order to input various operational commands. The display device 12 displays various operational windows, data, etc. which are needed for operation of the information processing device 1. The interface device 16 is an interface for connecting the information processing device 1 to a network or a computer terminal, and it comprises a modem, a router, and devices conforming to various interface standards.

The memory card slot 7 is provided so that insertion and removal of a memory card, such as an SD card, is possible. Upon insertion or removal of the SD card, the memory card slot 7 outputs an interrupt signal to an SD card status monitor driver (not illustrated).

The auxiliary memory device 13 is provided to store various files, data, etc.

The SD card inserted in the memory card slot 7 or the auxiliary memory device 13 is provided to store the program for causing the information processing device 1 to execute the respective processes of the memory card control unit, the program addition unit, the application unit, the media initializing unit, etc., and provided to store various files, data, etc. for use in the processes of the program.

At the time of startup of the information processing device 1, the program including the memory card control unit, the program addition unit, the application unit and the media initializing unit, is read from the SD card inserted in the memory card slot 7 or the auxiliary memory device 13. The memory device 14 is provided to store the read program.

The processing unit 15 performs the processes of the memory card control unit, the program addition unit, the application unit and the media initializing unit in accordance with the program stored in the memory device 14.

Next, a firmware distribution system which is related to the information processing device of the invention will be explained.

This firmware distribution system is installed in an external information processing device, such as a different personal computer, a different server device, etc., which is separate from the information processing device of FIG. 1.

If a request for distribution of a predetermined firmware is inputted by the user on the input device of the external information processing device, operation of the firmware distribution system is started. The applicant to which the present invention is assigned has already proposed a firmware distribution system which is disclosed in Japanese Laid-Open Patent Application No. 2004-303221.

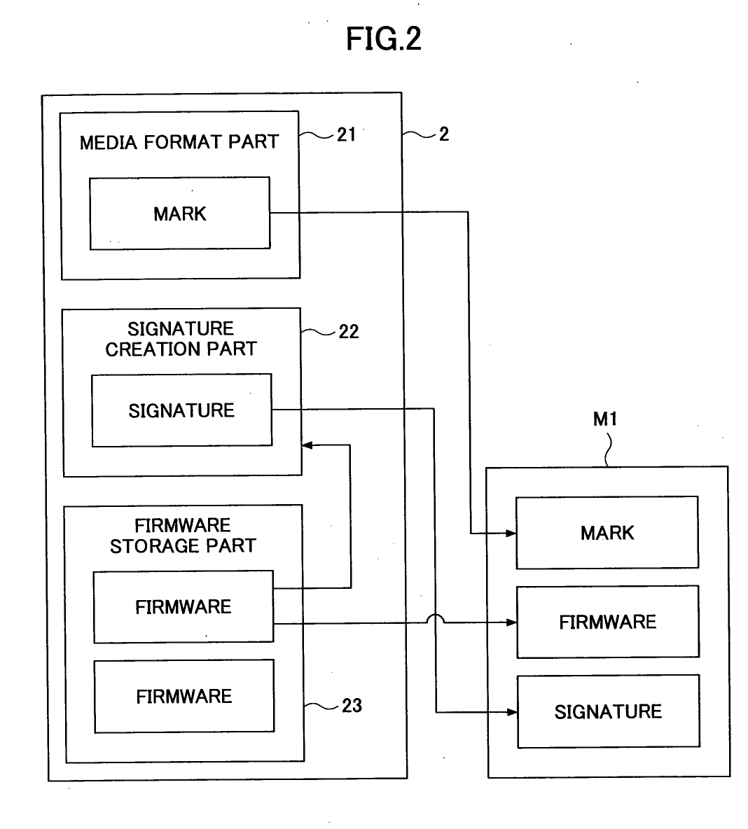

FIG. 2 shows the composition of the firmware distribution system.

As shown in FIG. 2, the firmware distribution system 2 comprises a media format part 21, a signature creation part 22, and a firmware storage part 23.

Although illustration is omitted, the external information processing device, such as a personal computer or a server device, is also constituted in the same manner so that it comprises the input device, the display device, the auxiliary memory device, the memory device, the processing unit, the interface device and the memory card slot, which are interconnected by the bus.

When the request of a predetermined firmware is inputted by the user, the firmware distribution system 2 reads the predetermined firmware, which is called from the auxiliary memory device and stored into the firmware storage part 23, and records the read firmware in a recording medium M1 which is inserted in the memory card slot. At the same time, the firmware distribution system 2 supplies the read firmware to the signature creation part 22.

The signature creation part 22 prepares an electronic signature by using the known the electronic signature creation method using the normal secret key, and records the signature in the recording medium M1.

Moreover, the firmware distribution system 2 causes the media format part 21 to prepare arbitrary marks, and records the marks in the recording medium M1. Thus, the recording medium (also called program medium) M1 in which the marks, the firmware and the signature are recorded is prepared.

The electronic signature is prepared and recorded in order to prevent unauthorized operation from being performed on the program medium by another information processing device (personal computer, etc.) which intends to initiate the firmware (program) after the firmware is recorded in the program medium.

The marks are arbitrary data which are given to the recording medium (program medium) M1 when the medium is being prepared, in order to identify the recording medium. For example, character strings (and/or numeric character strings) for storing the size of the recording medium may be used as the marks.

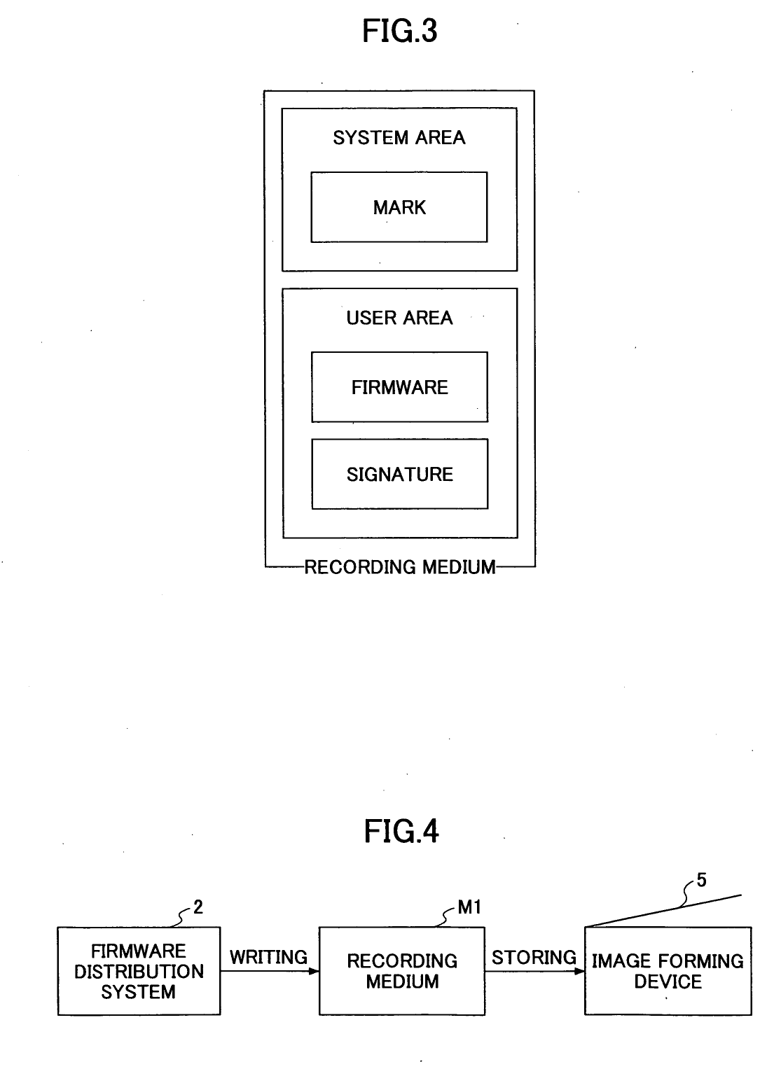

FIG. 3 shows the arrangement of objects on a recording medium. As shown in FIG. 3, in the recording medium generally, the system area and the user area are formed. The above-mentioned marks are contained in the system area of the recording medium, and the firmware and the signature are contained in the user area of the recording medium, respectively.

FIG. 4 shows the form of use of the recording medium in the firmware distribution system and the image forming device.

A recording medium (program medium) M1 is prepared by the firmware distribution system 2, and the recording medium M1 is inserted in the memory card slot of the image forming device 5. And the recording medium M1 is used for starting of a predetermined application program in the image forming device 5. Meanwhile, a normal recording medium M2 is also inserted in the memory card slot of the image forming device 5, and the normal recording medium M2 is used for rewriting of image data or the like in the image forming device 5.

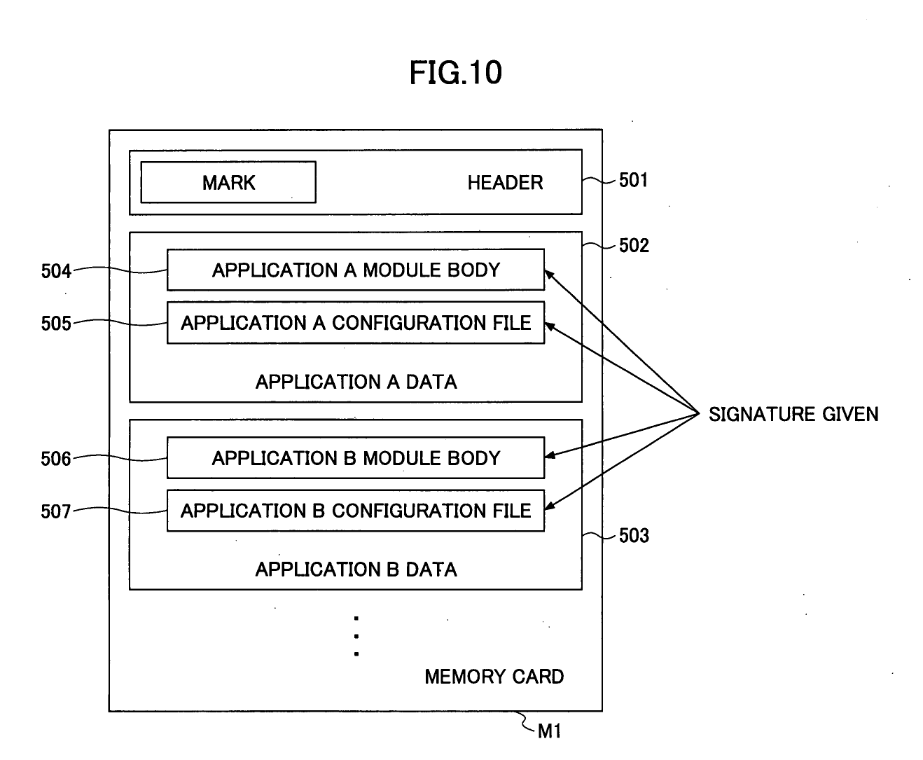

FIG. 10 shows the composition of a memory card which is prepared by the firmware distribution system.

As shown in FIG. 10, in the memory card M1 prepared by the firmware distribution system, a header 501, an application A data 502, and an application B data 503 are recorded. In the example of the memory card M1 of FIG. 10, a single electronic signature corresponds to the plurality of programs in common, and is given to the plurality of programs.

The marks prepared by the media format part 21 are contained in the header 501 which corresponds to the system area of the recording medium of FIG. 3.

The application A data 502 and the application B data 503 correspond to the user area of the recording medium of FIG. 3. In the application A data 502, the application A module body 504 and the configuration file 505 for application A are contained. In the application B data 503, the application B module body 506 and the configuration file 507 for application B are contained. Each of the application A module body 504 and the application B module body 506 represents the boot program for starting the application A and the application B, respectively. Each of the configuration file 505 for application A and the configuration file 507 for application B are configuration files for program starting of the application A and the application B, respectively.

Next, the composition of the MFP as an application device of the information processing device of the invention will be explained.

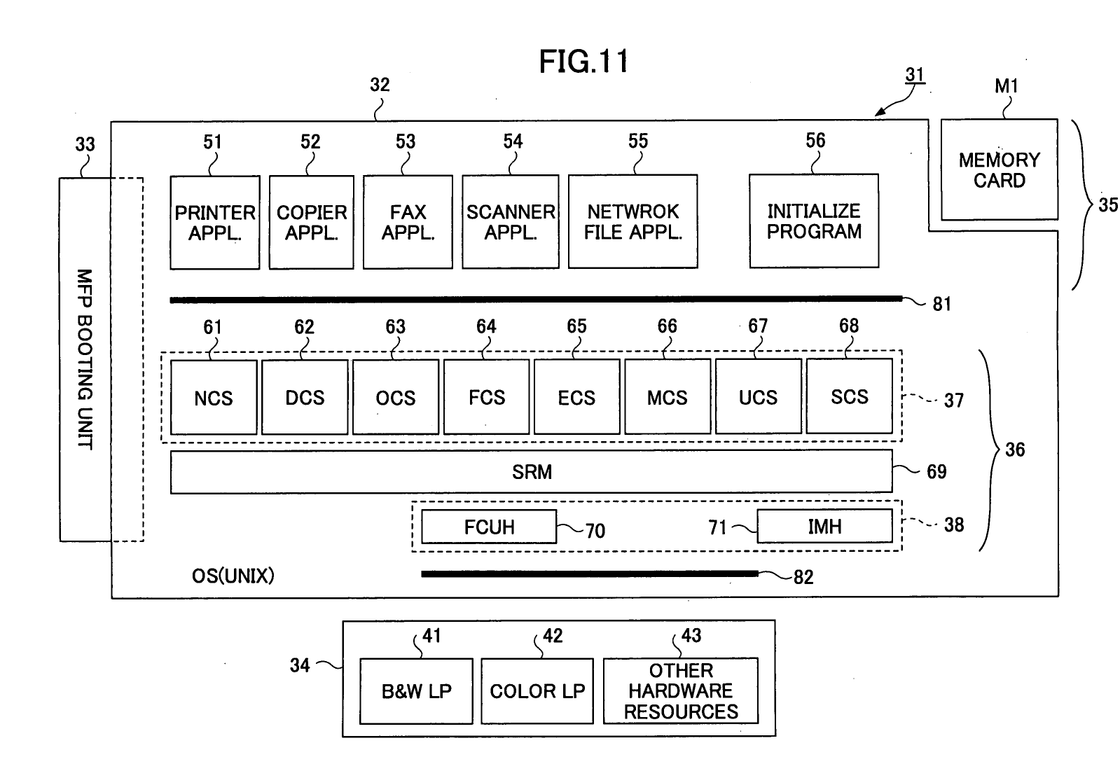

FIG. 11 shows the software composition of the image forming device in an embodiment of the invention. In this embodiment, the processing of the MFP will be described mainly. The processing of the information processing device is essentially the same as the processing of the MFP, and a description thereof will be omitted.

As shown in FIG. 11, the MFP 31 comprises the software group 32, the MFP booting unit 33, and the hardware resources 34.

When the power switch (not shown) of the MFP 31 is turned ON, the MFP booting unit 33 is caused to start execution the programs of the application layer 35 and the platform layer 36. For example, the MFP booting unit 33 reads the programs of the application layer 35 and the platform layer 36 from the hard disk drive (HDD) Then the MFP booting unit 33 transfers the read programs to the memory areas, and starts execution of the programs.

The hardware resources 34 include the monochrome laser printer (B&W LP) 41, the color laser printer (Color LP) 42, and the other hardware resources 43 such as the scanner, the fax, etc.

The software group 32 includes the application layer 35 and the platform layer 36 which are operated on the operating system (OS), such as UNIX (registered trademark). The application layer 35 includes the programs which perform respective processes specific to the user services related to the image formation, such as the printer, the copier, the facsimile, and the scanner.

The application layer 35 includes the printer application 51 which is the application program for the printer, the copier application 52 which is the application program for the copier, the facsimile application 53 which is the application program for the facsimile, the scanner application 54 which is the application program for the scanner, the network file application 55 which is the application program for the network file, and the initialize program 56 which is the application program for initializing the recording medium M1, such as a SD card.

If a new application program (firmware) is installed in the MFP 31 by using the above-mentioned recording medium M1, then the application layer 35 further includes the new application program.

Moreover, the platform layer 36 includes the control service layer 37 which interprets the processing request from the application layer 35 and generates the acquisition request of hardware resources 34, the system resource manager (SRM) 69 which manages one or more hardware resources 34 and arbitrates the acquisition request from the control service layer 37, and the handler layer 38 which manages the hardware resources 34 according to the acquisition request from SRM 69.

The control service layer 37 includes one or more service modules which include the network control service (NCS) 61, the delivery control service (DCS) 62, the operation panel control service (OCS) 63, the facsimile control service (FCS) 64, the engine control service (ECS) 65, the memory-control service (MCS) 66, the user information control service (UCS) 67, and the system control service (SCS) 68.

In addition, the platform layer 36 is provided to have the API 81 which makes it possible to receive the processing request from the application layer 35 according to a pre-defined function. The OS carries out parallel execution of each program of the application layer 35 and the platform layer 36 as a process.

The process of NCS 61 offers the service which can be used in common to the application which needs network I/O, distributes the data received by each protocol from the network side to each application, or performs agency at the time of transmitting the data from each application to the network side.

For example, NCS 61 controls the data communication with a network device connected through the network, by using the HTTP (hypertext transfer protocol) according to the HTTPD (hypertext transfer protocol daemon).

The process of DCS 62 controls distribution of the accumulated documents etc. The process of OCS 63 controls the operation panel which is the interface between the user and the MFP 31 used as the unit of communication of information.

The process of FCS 64 provides the application API for performing the facsimile transmission and reception through the PSTN or ISDN network used by the application layer 35, the registration/access of the various facsimile data managed by the memory for backup, the facsimile reading, the facsimile reception printing, etc.

The process of ECS 65 controls the engine units, such as the monochrome laser printer 41, the color laser printer 42, and the other hardware resources 43.

The process of MCS 66 performs the memory control of the acquisition and releasing of the memory and release, the use of HDD, the compression and decompression of the image data, etc. The process of UCS 67 manages the user information.

The process of SCS 68 processes the application management, the operation panel control, the system screen display, the LED display, the hardware-resources management, the interruption application control, etc.

The process of SRM 69 performs control of the system and management of the hardware resources 34 in association with SCS 68.

For example, according to the acquisition request using the hardware resources 34 from the high order layer, the process of SRM 69 arbitrates the request and carries out the execution control.

Specifically, the process of SRM 69 determines whether the hardware resources 34 to which the acquisition request is sent can be used (or whether the hardware resources 34 are already used by another acquisition request). If the use of the hardware resources 2 is possible, the process of SRM 69 will notify to the high order layer that the hardware resources 34 to which the acquisition request is sent can be used.

Moreover, the process of SRM 69 performs the scheduling of the acquisition request from the high order layer for using the hardware resources 34, and carries out the contents of the request (for example, paper conveyance with the printer engine, imaging operation, memory reservation, file generating, etc.) directly.

Moreover, the handler layer 38 includes the facsimile control-unit handler (FCUH) 70 which manages the facsimile control unit (FCU), and the image memory handler (IMH) 71 which manages the assignment of the memory to the process and the memory assigned to the process.

SRM 69 and FCUH 70 send the processing request to the hardware resources 34 using the engine I/F 82 which makes it possible to send the processing request to the hardware resources 34 according to the pre-defined function.

The MFP 31 can process the common processing, shared by the respective applications, in the platform layer 36 in a concentrated manner.

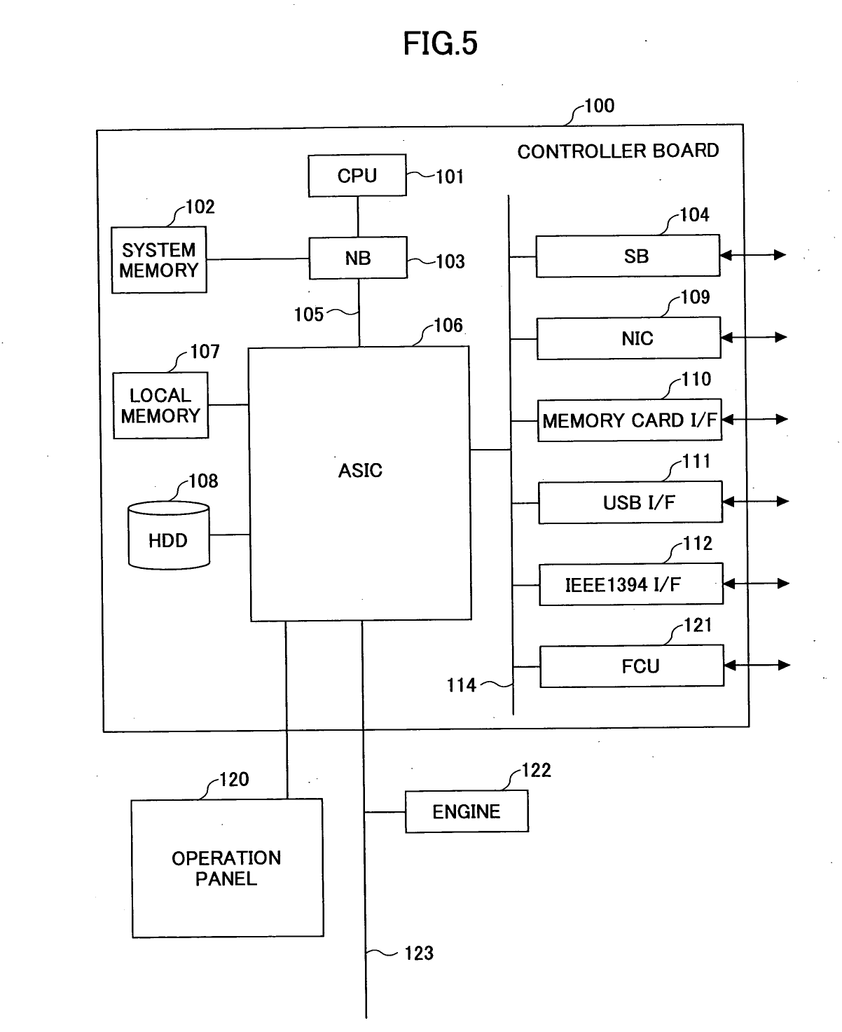

Next, a description will be given of the hardware composition of the image forming device of this embodiment. FIG. 5 shows the hardware composition of the multi-function peripheral (MFP) of this embodiment.

As shown in FIG. 5, the MFP 31 of this embodiment includes a controller board 100, an operation panel 120, a FCU (fax control unit) 121, a USB (universal serial bus) interface 111, an IEEE1394 interface 112, and an engine 122.

The controller board 100 includes a CPU 101, an ASIC 106, a HDD 108, a system memory 102, a local memory 107, a north bridge (NB) 103, a south bridge (SB) 104, and a network interface card (NIC) 109.

The operation panel 120 is connected to the ASIC 106 of the controller board 100. Moreover, the FCU 121, the USB interface 111, the IEEE1394 interface 112 and the engine 122 are connected to the ASIC 106 of the controller board 100 by the PCI (peripheral component interconnect) bus.

In the controller board 100, the local memory 107, the HDD 108, and the network interface card 109 are connected to the ASIC 106, and the CPU 101 and the ASIC 106 are connected to the ASIC 106 through the NB 103 which is the CPU chip set.

Thus, if the CPU 101 and the ASIC 106 are connected through the NB 103, when the interface of the CPU 101 is not exhibited, it can resolve the problem.

Moreover, the ASIC 106 and the NB 103 are connected through the AGP (accelerated graphics port) 105, not through the PCI bus. In order to carry out execution control of one or more processes which are constituted by the application layer 35 and the platform layer 36 of FIG. 11, the ASIC 106 and the NB 103 are connected through the AGP 105, not through the low-speed PCI bus. It is possible to prevent the lowering of the performance.

The CPU 101 performs the control of the whole multi-function peripheral. The CPU 101 starts execution of NCS 61, DCS 62, OCS 63, FCS 64, ECS 65, MCS 66, UCS 67, SCS 68, SRM 69, FCUH 70, and IMH 71 as a process, and performs the execution of each process on the OS. Moreover, the CPU 101 starts execution of the printer application 51, the copier application 52, the facsimile application 53, the scanner application 44, the network file application 55 and the initialize program 56 which constitute the application layer 35.

NB 103 is the bridge which is provided for connecting the CPU 101, the system memory 102, the SB 104 and the ASIC 106.

The system memory 102 is a memory used for image drawing of the MFP 31.

SB 104 is the bridge which is provided for connecting the NB 103 and ROM, and the PCI bus and the peripheral devices.

Moreover, the local memory 107 is the memory used as the image buffer for the copying, and the encoding buffer.

The ASIC 106 is an application-specific integrated circuit for image-processing uses including the hardware for image processing.

HDD 108 is the storage device for performing accumulation of images, accumulation of document data, accumulation of programs, accumulation of font data, accumulation of forms, etc.

The operation panel 120 is provided to display the operational messages to the user and receive the input operational commands from the user.

When the recording medium M2 is inserted, the information processing device of the invention is capable of initializing the recording medium M2. The information processing device of the invention has the mechanism for preventing the recording medium M1 from being erroneously initialized by operation of the user at this time.

Next, the mechanism for preventing the recording medium M1 (in which the program is recorded) from being erroneously initialized, which is provided in the information processing device of the invention will be explained.

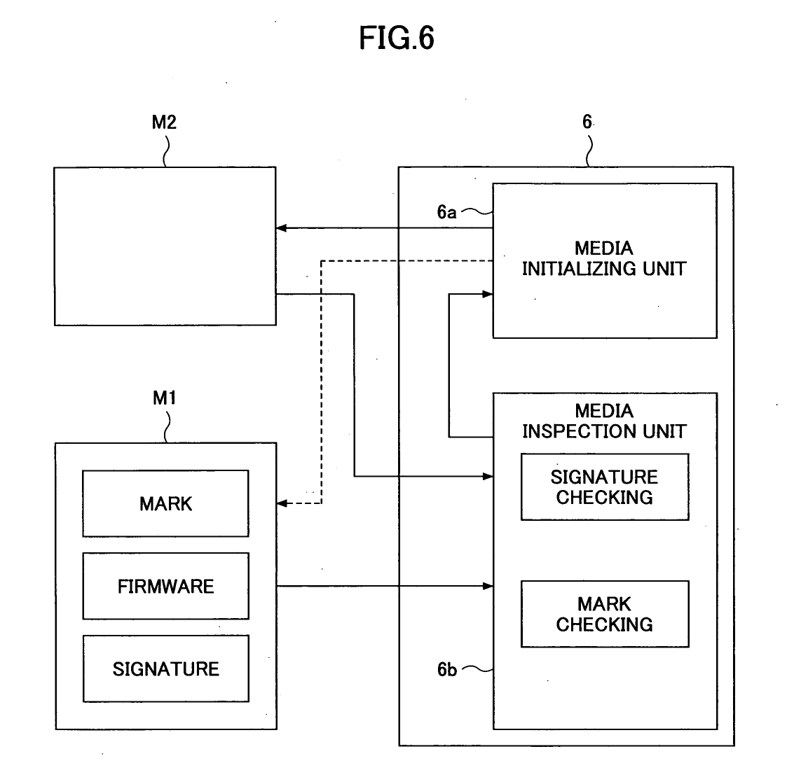

FIG. 6 is a diagram for explaining the mechanism for preventing the recording medium from being initialized erroneously.

As shown in FIG. 6, if initialization of the recording medium which is inserted in the memory card slot is requested by the user on the input device of the information processing device 1 or the image forming device 5, the information processing device 1 or the image forming device 5 starts the initialize program 6, so that a media initializing unit 6a and a media inspection unit 6b are developed to the memory device.

Similarly, in the case of the MFP of FIG. 5, the CPU101 starts the initialize program 56 of FIG. 11, so that the media initializing unit 6a and the media inspection unit 6b are developed to the memory device.

The media inspection unit 6b accesses the recording medium (the normal recording medium M2 or the program medium M1 in which the firmware is recorded), acquires the electronic signature and the marks from the recording medium, and inspects authenticity of each item of the identification information of the recording medium. This inspection is performed to determine whether the acquired signature and the acquired marks are authentic.

Specifically, it is determined whether the signature and marks which are acquired from the recording medium match with a predetermined electronic signature and predetermined marks which are stored beforehand in the initialize program 6, respectively. The inspection results of the respective items of the identification information of the recording medium are passed from the media inspection unit 6b to the media initializing unit 6a.

The media initializing unit 6a is provided so that it does not initialize the recording medium when it is detected that at least one of the inspection results of the acquired signature and the acquired marks is authentic.

In order to raise the safety and operability for prevention of erroneous initialization of the recording medium in which the program is recorded, the information processing device of the invention is provided so that when it is detected that at least one of the inspection results of the acquired signature and the acquired marks is authentic, the information processing device of the invention inhibits execution of initialization of the recording medium.

For example, in the case of the program medium M1, if unauthorized operation is not performed on the recording medium M1 by another personal computer, then both the inspection results of the acquired signature and the acquired marks show that they are authentic. In this case, the media initializing unit 6a does not initialize the program medium M1 (which is indicated by the leftward dotted-line arrow in FIG. 6). On the other hand, in the case of the normal recording medium M2, there is no possibility that both the inspection results of the acquired signature and the acquired marks show that they are authentic. Thus, the media initializing unit 6a performs initialization of the recording medium M2 (which is indicated by the leftward solid-line arrow in FIG. 6).

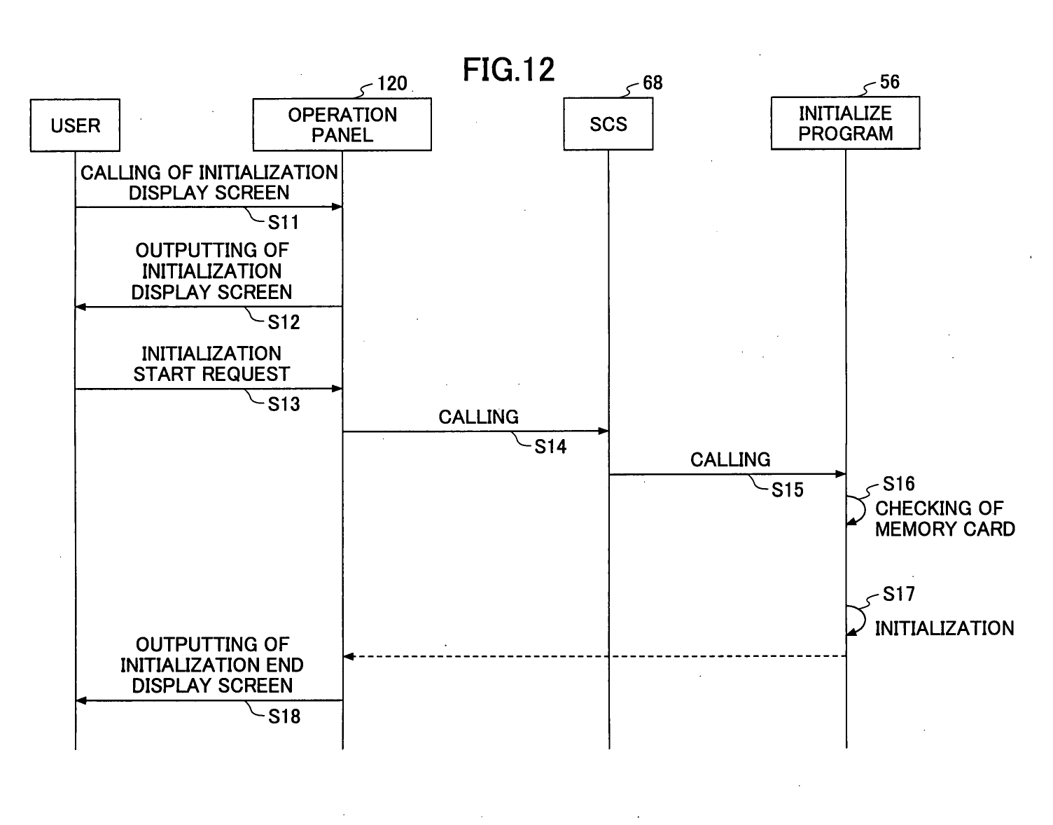

FIG. 12 is a diagram for explaining the initialization procedure of the recording medium which is performed by the user.

Hereafter, the initialization procedure of the recording medium will be explained by making the case of the MFP of FIG. 5 into an example.

In the state where the recording medium (M1 or M2) is inserted in the memory card slot (memory card I/F 110), the user calls the initialization display screen of the recording medium by performing selection operation of a given location in the display of the operation panel 120 (S11).

In response to the request from the user, the operation panel 120 outputs an initialization display screen of the recording medium on the display (S12). The user inputs an initialization start request by performing selection operation of a given location in the initialization display screen of the recording medium (S13).

In response to the initialization start request from the user, the operation panel 120 transmits a request of initialization execution (calling) to the system control service (SCS) 68 of the MFP (S14).

In response to the request from the operation panel 120, the system control service (SCS) 68 transmits a request of initialization execution (calling) to the initialize program 56 (S15).

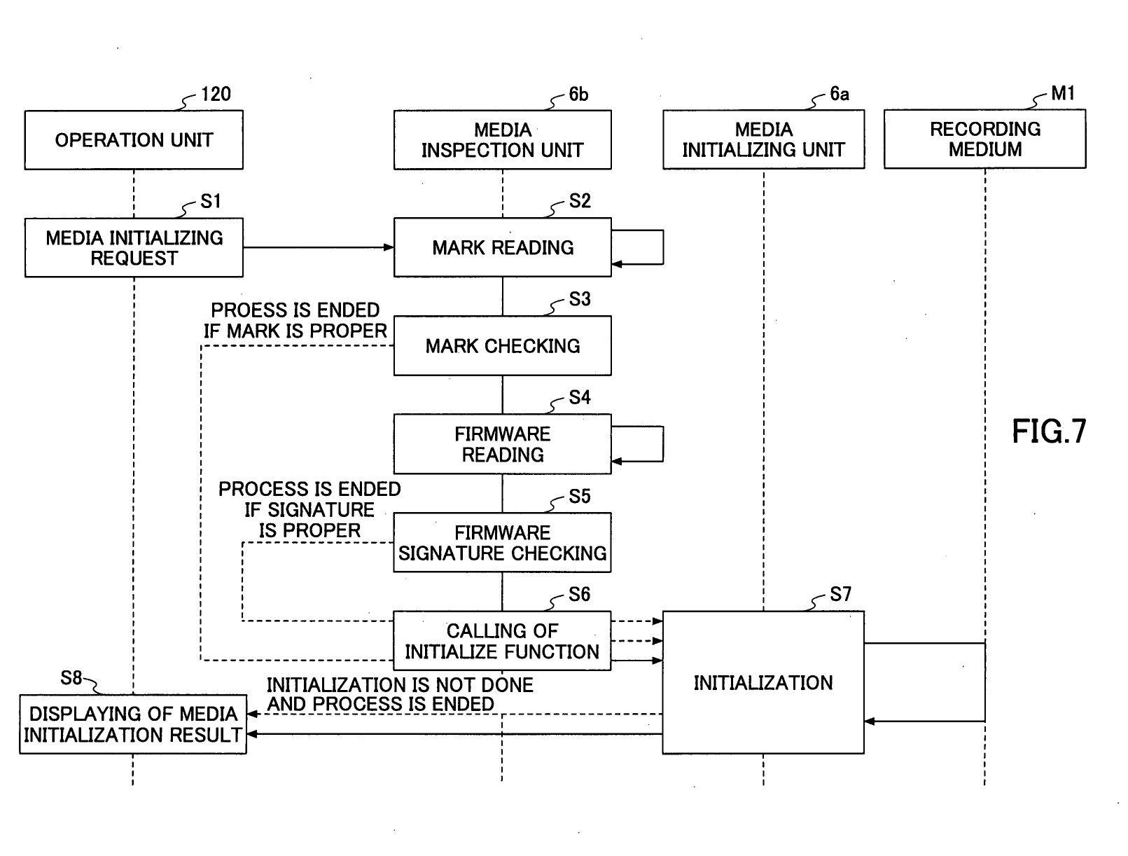

When the request of initialization execution is received, the initialize program 56 checks correctness of initialization of the recording medium (M1 or M2) which is inserted in the memory card slot (S16). The procedure for checking correctness of initialization of the recording medium by the initialize program will be explained later with reference to FIG. 7.

When it is detected that the recording medium which is inserted in the memory card slot is the normal recording medium M2, the initialize program 56 initializes that recording medium (S17).

After the initialization of the recording medium is completed, the initialize program 56 transmits a notice of the end of initialization to the operation panel 120 through the SCS 68.

When the notice of the end of initialization from the initialize program 56 is received, the operation panel 120 outputs an initialization end display screen on the display, and ends the initialization procedure (S18).

FIG. 7 is a flowchart for explaining the initialization correctness detection process for a recording medium, which is performed by the initialize program.

As shown in FIG. 7, when a request of initialization of the recording medium (M1 or M2) is inputted by the user on the operation panel 120 (or the input device 11), the MFP 31 (or the information processing device 1) starts the initialize program 56 (or the initialize program 6) (S1). The media initializing unit 6a and the media inspection unit 6b are developed to the memory device.

The media inspection unit 6b accesses the recording medium (M1 or M2) which is inserted in the memory card slot 7, and reads the marks from the recording medium (S2).

The media inspection unit 6b checks authenticity of the read marks (S3). The method for checking authenticity of the marks will be described later.

When the inspection result of the step S3 indicates that the marks are authentic, the media inspection unit 6b supplies the inspection result to the media initializing unit 6a.

The media inspection unit 6b accesses the recording medium (M1 or M2) again, and reads the firmware from the recording medium (S4).

The media inspection unit 6b checks authenticity of the read firmware (S5). In this inspection, the media inspection unit 6b compares the electronic signature which is obtained by decrypting the electronic signature derived from the firmware of the recording medium, using the public key, with the electronic signature of the firmware stored beforehand in the initialize program 6. The media inspection unit 6b determines whether a match occurs between the signatures by the comparison result.

When the inspection result of the step S5 indicates that the read firmware is authentic, the media inspection unit 6b supplies the inspection result to the media initializing unit 6a. In this case, the inspection result indicating the marks are authentic is already received at the media initializing unit 6a. If the recording medium which is inserted in the memory card slot is the program medium M1, there is no possibility that unauthorized operation may be performed on the recording medium Ml. The media initializing unit 6a does not perform the initialization of the program medium M1, and outputs the media initialization result to the display of the operation panel 120 (S8). And the initialization correctness detection process is ended.

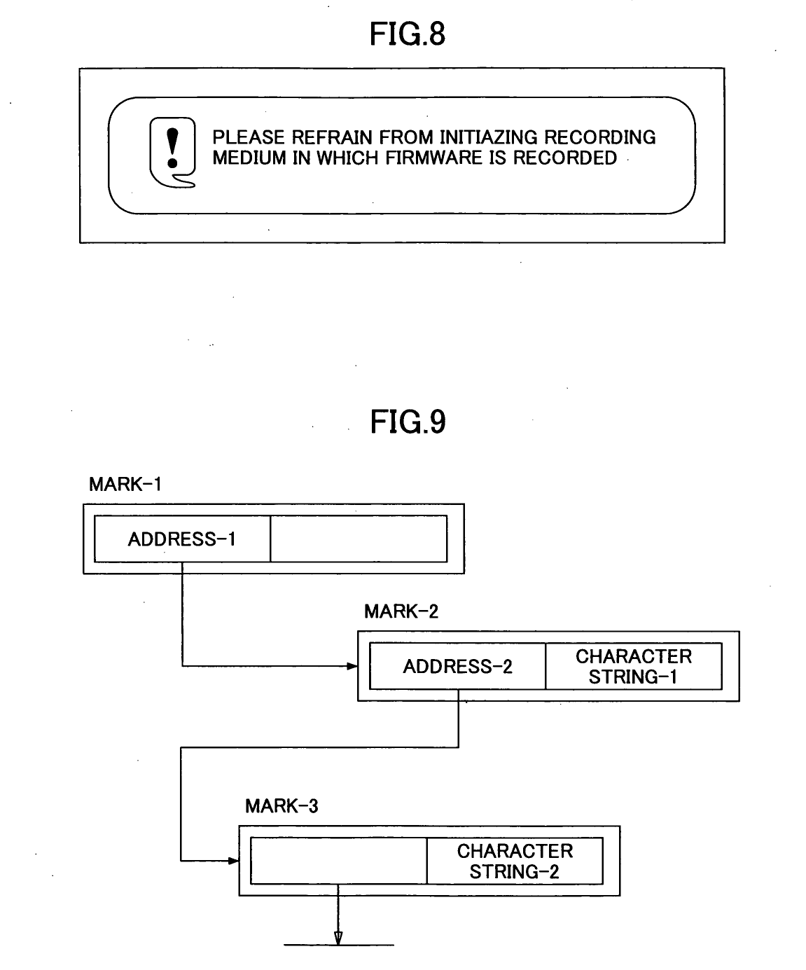

FIG. 8 shows an example of the display screen which is outputted to the display of the operation panel 120 by the media initializing unit 6a at the step S8, when the recording medium inserted in the memory card slot is the program medium M1.

In this case, the message, such as “please refrain from initializing the recording medium in which the firmware is recorded”, is outputted to the display of the operation panel 120 by the media initializing unit 6a.

On the other hand, when the inspection result of the step S5 of FIG. 7 indicates that the firmware is not authentic, the media inspection unit 6b calls an initialize function, and supplies the initialize function to the media initializing unit 6a (S6).

The media initializing unit 6a accesses the recording medium of the memory card slot, and initializes the recording medium (in this case, the normal recording medium M2) (S7).

The media initializing unit 6a outputs the message, such as “initialization (formatting) of the recording medium is under execution” to the display of the operation panel 120 (S8). And the initialization correctness detection process is ended.

In order to perform the above-described initialization correctness detection process, the procedure is described as a computer program with general program language, this program is recorded on an arbitrary recording medium, and this computer program is installed in the auxiliary memory device (HDD) of the information processing device 1 or the image forming device 5. In response to the request of initialization inputted by the user, the information processing device 1 or the image forming device 5 reads the computer program from the HDD and develops the read program to the memory device. Thus, the above-described initialization correctness detection process can be easily carried out by the information processing device of the invention.

Next, the checking method of the marks acquired from the recording medium will be explained. The marks are provided in order to prevent unauthorized operation from being performed by another personal computer different from the information processing device authorized to start the program. The marks are constituted to include the plurality of marks linked by the addresses being given thereto, respectively, and the character strings (and/or the numerical character strings) formed in the predetermined marks among the plurality of marks.

The address given to each mark links the plurality of marks in the recording medium, and enables searching of each mark respectively.

As mentioned above with FIG. 10, when the firmware distribution system 2 prepares the memory card M1, the firmware distribution system 2 writes the plurality of marks linked by the addresses being given, to the header 501 of the memory card M1.

In this case, the plurality of marks are recorded at two or more specified positions in the header 501 separately. At this time, the character strings formed in the address of each mark recorded in the header 501 of the memory card M1 and a predetermined mark are set up beforehand as the predetermined addresses and the predetermined character strings.

In order to check authenticity of the marks acquired from the recording medium M1, it is necessary to store, in the initialize program 56, the addresses and the character strings which are set up beforehand as authentication information concerning the above-mentioned marks recorded in the header 501 of the recording medium M1.

FIG. 9 is a diagram for explaining an example of the mark checking method applied to the initialize program.

As shown in FIG. 9, a plurality of marks (three marks in the example of FIG. 9) which are linked by addresses given to the plurality of marks, respectively, are contained in the header 501 of the recording medium.

Among the plurality of marks, the first mark-1 contains only the address-1. An address value indicating the front-end position of the next mark-2 in the medium is given to this address-1. The next mark-2 contains the address-2 and a predetermined character string-1, and an address value indicating the front-end position of the last mark-3 in the medium is given to the address-2. The last mark-3 contains only a predetermined character string-2. Mutually different character strings are written in as the character string-1 and the character string-2. An address value indicating the front-end position of the first mark-1 in the medium is predetermined as that indicating a given location of the header 501 of the recording medium.

When the media inspection unit 6b accesses the recording medium in which the above-described marks of FIG. 9 are recorded, the media inspection unit 6b first reads the address-1 of the first mark-1, so that the front-end position of the next mark-2 in the medium is detected, and the character string 1 contained in the next mark-2 is acquired. Similarly, the media inspection unit 6b reads the address-2 of the next mark-2, so that the character string-2 contained in the last mark-3 is acquired.

The character string-1 of the mark-2 and the character string-2 of the mark-3 can be acquired by the address value of each of the address-1 and the address-2, and the media inspection unit 6b determines whether the acquired character string-1 and the acquired character string-2 match with the predetermined first character string and the predetermined second character string stored beforehand in the initialize program 6, respectively. And each of the inspection results is notified to the media initializing unit 6a from the media inspection unit 6b.

When a match of at least one of the acquired character string-1 and the acquired character string-2 occurs at this time, the media initializing unit 6a does not initialize the recording medium. The purpose of this processing by the media initializing unit 6a is to raise the safety and operability for prevention of erroneous initialization of the recording medium in which the program is recorded.

The mark checking method is not limited only to the example of FIG. 9. For example, an alternative mark checking method may be such that, when the plurality of marks linked by the addresses given thereto are searched and the last mark is reached, the method can acquire the identification information of the recording medium.

As described in the foregoing, the initialization correctness detection processing of the invention is useful for the information processing device and the image forming device, in order to prevent the recording medium in which the program is recorded from being erroneously initialized by operation of the user who intends to initialize it before adding the user data to the recording medium which is inserted in the SD card slot.

The present invention is not limited to the above-described embodiments, and variations and modifications may be made without departing from the scope of the present invention.

Further, the present application is based on and claims the benefit of priority of Japanese patent application No. 2005-062622, filed on Mar. 7, 2005, and Japanese patent application No. 2006-045341, filed on Feb. 22, 2006, the entire contents of which are hereby incorporated by reference.

What is claimed is:

1. An information processing device which prevents erroneous initialization of a removable recording medium in which a program is recorded, comprising:
an acquisition unit which acquires the program and identification information of the recording medium from the recording medium;
a first inspection unit checking authenticity of the acquired program;
a second inspection unit checking authenticity of the acquired identification information; and
a determination unit determining correctness of initialization of the recording medium based on inspection results of the first and second inspection units.

2. The information processing device according to claim 1 wherein the identification information includes a plurality of marks which are linked by address information being given respectively, and a plurality of character strings contained in the plurality of marks respectively.

3. The information processing device according to claim 1 wherein the second inspection unit is provided to search a plurality of marks, contained in the identification information, by using address information given to each of the plurality of marks, and provided to determine whether a character string contained in a searched mark matches with a predetermined character string for the recording medium.

4. The information processing device according to claim 2 wherein the address information given to each of the plurality of marks links the plurality of marks in the recording medium and enables searching of each mark.

5. The information processing device according to claim 1 wherein execution of initialization of the recording medium is inhibited when at least one of the inspection results of the first and second inspection units indicates authenticity of the program or the identification information.

6. An information processing method which prevents erroneous initialization of a removable recording medium in which a program is recorded, comprising:
an acquisition step of acquiring the program and identification information of the recording medium from the recording medium;
a first inspection step of checking authenticity of the acquired program;
a second inspection step of checking authenticity of the acquired identification information; and
a determination step of determining correctness of initialization of the recording medium based on inspection results of the first and second inspection steps.

7. The information processing method according to claim 6 wherein the identification information includes a plurality of marks which are linked by address information being given respectively, and a plurality of character strings contained in the plurality of marks respectively.

8. The information processing method according to claim 6 wherein the second inspection step is provided to search a plurality of marks, contained in the identification information, by using address information given to each of the plurality of marks, and provided to determine whether a character string contained in a searched mark matches with a predetermined character string for the recording medium.

9. The information processing method according to claim 7 wherein the address information given to each of the plurality of marks links the plurality of marks and enables searching of each mark.

10. The information processing method according to claim 6 wherein execution of initialization of the recording medium is inhibited when at least one of the inspection results of the first and second inspection steps indicates authenticity of the program or the identification information.

11. A computer program product for causing a computer to execute an information processing method which prevents erroneous initialization of a removable recording medium in which a program is recorded, the method comprising:
an acquisition step of acquiring the program and identification information of the recording medium from the recording medium;
a first inspection step of checking authenticity of the acquired program;
a second inspection step of checking authenticity of the acquired identification information; and
a determination step of determining correctness of initialization of the recording medium based on inspection results of the first and second inspection steps.

12. A computer-readable recording medium embodied therein for causing a computer to execute an information processing method which prevents erroneous initialization of a removable recording medium in which a program is recorded, the method comprising:
an acquisition step of acquiring the program and identification information of the recording medium from the recording medium;
a first inspection step of checking authenticity of the acquired program;
a second inspection step of checking authenticity of the acquired identification information; and
a determination step of determining correctness of initialization of the recording medium based on inspection results of the first and second inspection steps.
